(19) United States
(12) Patent Application Publication
(10) Pub. No.: US 2005/0161502 A1
(43) Pub. Date: Jul. 28, 2005

(54) Remote terminal check payment with automated transmittal

(75) Inventors: Newton James Smith JR., Austin, TX (US); Herman Rodriguez, Austin, TX (US); Clifford Jay Spinac, Austin, TX (US)

Correspondence Address: Darcell Walker, Suite 250, 9301 Southwest Freeway, Houston, TX, 77074, US

(73) Assignee: International Business Machines Corporation, Armonk, NY (US)

(21) Appl. No.: 10/765,774

(22) Filed: Jan. 27, 2004

(51) Int. Cl. G06F 17/60; G06F 7/08

(52) U.S. Cl. 235/379; 705/17

(57) ABSTRACT

The present invention provides a method for paying bills by check at a remote special-purpose kiosk terminal location. The customer selects a payee from the list displayed on the terminal screen. The customer inserts a statement/bill from that payee into the terminal document feeder. The terminal scans the statement and presents payment information for the customer to verify. The customer then inserts a check into the terminal and selects a form of payment. If the customer selects an electronic form of payment, the terminal will generate an electronic check based routing information scanned from the inserted check. With the electronic check, funds from the customer account are electronically sent to the payee. If the customer selects a physical check payment method, the inserted check is stored in the terminal in a location designated for that payee. The bill is considered paid when the check in stored in the terminal. With either method, the customer will receive a receipt verifying the payment.

### FIELD OF THE INVENTION

This invention relates to a method and system for paying bills using a remote computer terminal such as a special-purpose kiosk terminal and in particular to a method and system for paying bills by check via a remote special-purpose kiosk terminal such that the payment is considered paid at the time the payment is deposited into the remote kiosk terminal.

### BACKGROUND OF THE INVENTION

Today, numerous processes and devices exist for facilitating electronic payments. Virtually, all domestic banking institutions offer customers the ability to conduct a limited number of electronic transactions either from an automated teller machine (ATM) located on-site at the institution, or from a remote ATM serving the institution. The remote services are made possible in part through the development of communications systems that provide for the interconnection of many clearing-house or regional, national, or international electronic funds transfer (EFT) networks. These networks are specialized digital packet networks that communicate with various ATM transaction processors and service providers using standard message protocols developed by ANSI and others.

In addition to the ATM devices, special-purpose machines known as “kiosk” terminals enable persons to have computer access from remote locations. These kiosk terminals are usually located in public facilities such as supermarkets or shopping malls. From one of these terminals a person can access a global computing network, read electronic mail messages or access a large variety of information.

Although many transactions today, including bill paying, are done by means of electronic transaction, most people still pay their bills by mailing in a check. In some cases, persons can pay bills by check at a local merchant, such as a supermarket. These locations serve as clearing-houses for bill payments such as utility, telephone and cable television bills. These types of payments are often made close to or on the due date, with the assurance that the payment through the merchant is equivalent to directly paying the bill to the payee. Although the payee has not yet received the funds, the bill is considered paid when the merchant location receives the check from the payer. The merchant often charges a handling fee for this service. These collected checks require a large amount of manual processing.

People who want to use checks for payments, but are also close to the payment deadline, use this merchant payment process to timely pay their bills. In addition, other customers who do not want to or cannot use check payments or electronic payment systems also use this merchant payment process to pay their bills with cash This payment process additionally allows the customer to make payments by check in real time without being subject to postal delays.

Although this current system allows customers to timely pay their bills by paying the merchant, this system is still inefficient and does not take advantage of the existing technology in this area. The current system requires a teller who physically receives the payment (check) from the customer. Since the checks are for a variety of bills, it is necessary to sort the checks. At some point, representatives of the payees collect the checks or the merchant deposits the checks directly into the payees' accounts. What is needed is a method by which check payments can be extended to customers via an automated method. This automated method can be accomplished by use of a kiosk terminal, which can scan checks and transmit the payments to the payees electronically, or collect the tangible check instrument for payment of the payees.

### SUMMARY OF THE INVENTION

It is an objective of the present invention to provide an automated method of bill payment at a special-purpose remotely located computer terminal such as a kiosk terminal.

It is a second objective of the present invention to provide an automated method of bill payment using a check at a special-purpose remotely located kiosk terminal.

It is a third objective of the present invention to provide a method of bill payment at a remotely located kiosk terminal using a check instrument wherein the payer receives credit for making the payment at the time the check is submitted into the terminal.

It is a fourth objective of the present invention to provide a method and system for paying multiple bills from one special-purpose machine such as a kiosk terminal machine.

The present invention provides a method for paying bills by check at a computer terminal location. The main concept of this invention is to allow the customer to make payments by check using the remotely located kiosk terminal. The customer writes a check as normal, and can use kiosk terminal to conduct the transaction. The customer then selects a payee from a list displayed on the terminal screen. The selection of a particular payee defines for the method of the invention, certain characteristics about this transaction such as the format of the bill/statement. The customer then inserts the bill/statement from the payee that the customer will pay. The terminal will read certain information from the bill based on the selected payee. The customer inserts the completed check into the terminal document feeder, and the terminal scans the check and then provides the option to transmit the payment electronically to the payee. A check written to “City of Austin Utilities” would be scanned and sent for e-check payment to the City of Austin Utilities department. In the alternative, this check deposited into this terminal could be sent manually to the payee or a bank. This present invention provides a convenience to the user, minimizes the manual processing, and allows for instant bill paying by check, wherein the bill is considered paid at the time it is deposited in the remote terminal.

### DESCRIPTION OF THE INVENTION

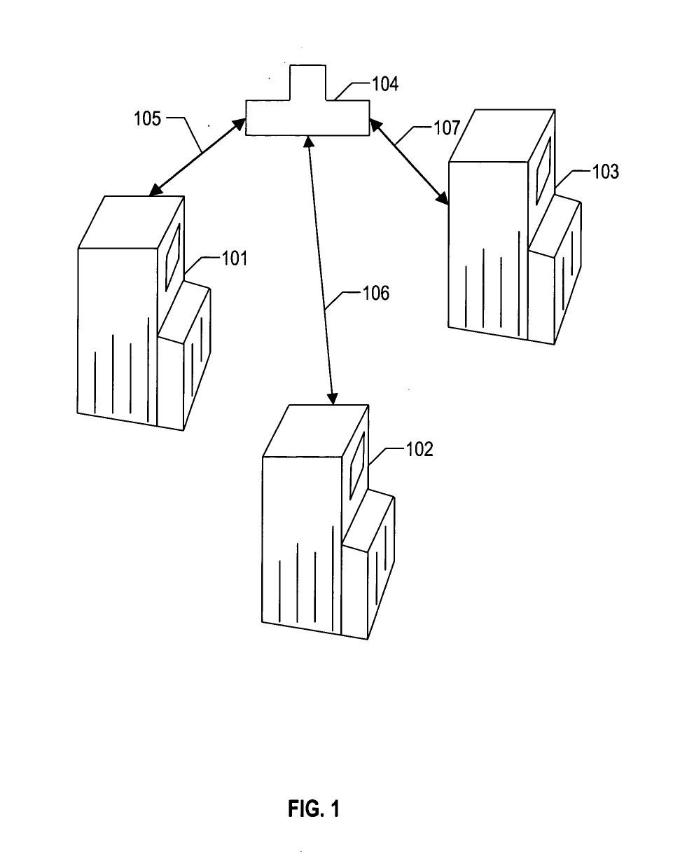

FIG. 1 illustrates a network configuration of remote kiosk terminals that can be used in the implementation of the present invention.

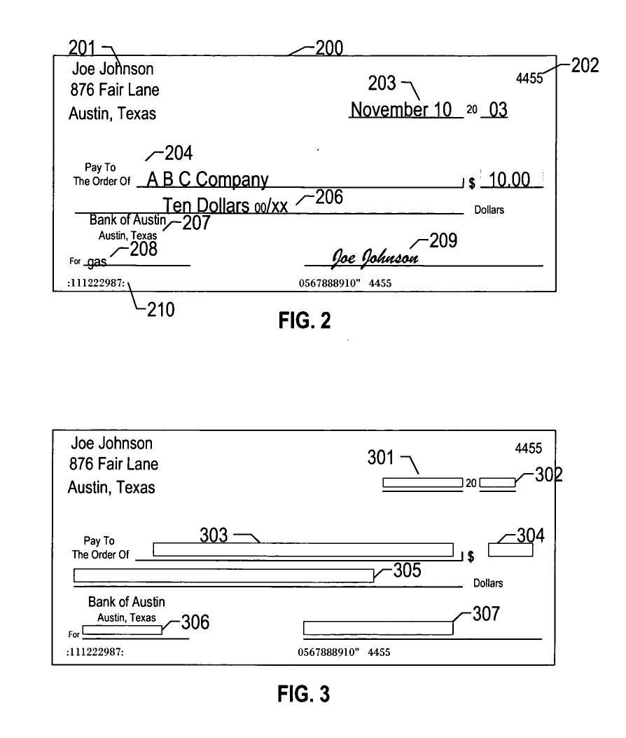

FIG. 2 is an illustration of a typical blank personal check that is used when paying bills by check.

FIG. 3 is an illustration of the blank check of FIG. 2 showing designated information fields within the check as outlined by the banking industry.

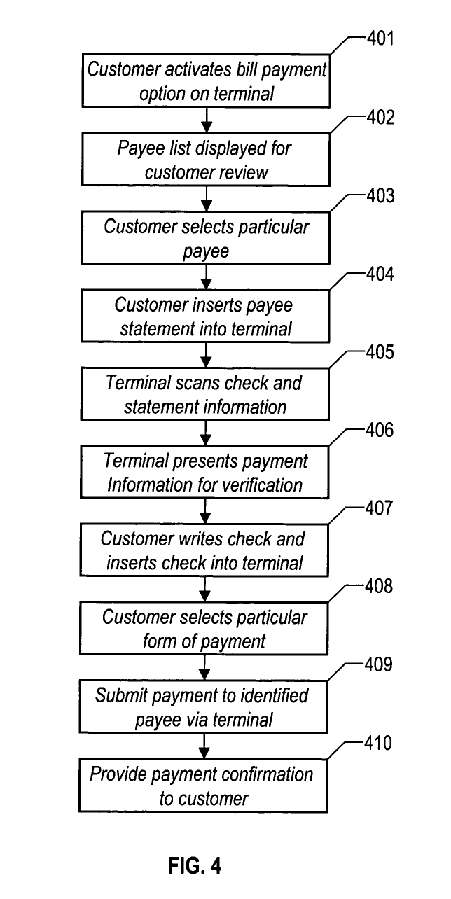

FIG. 4 is a flow diagram of the basic steps in the implementation of the method of the present invention.

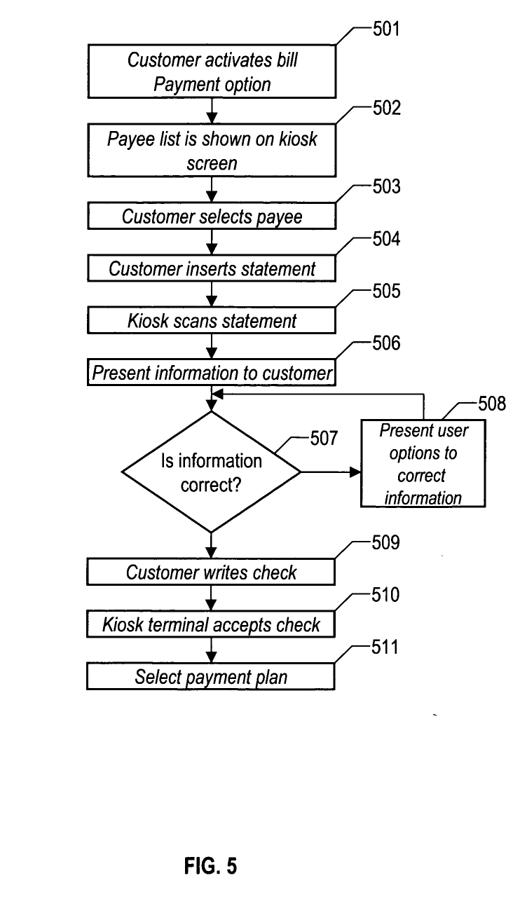

FIG. 5 is a flow diagram of the steps in the implementation of phase one of the method of the present invention.

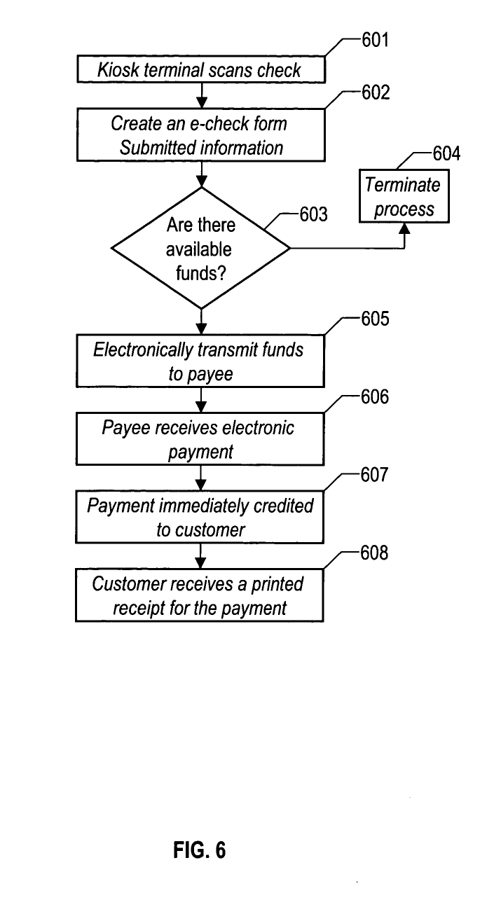

FIG. 6 is a flow diagram of the steps in phase two of the method of the invention when the customer selects to have the funds for the check paid electronically.

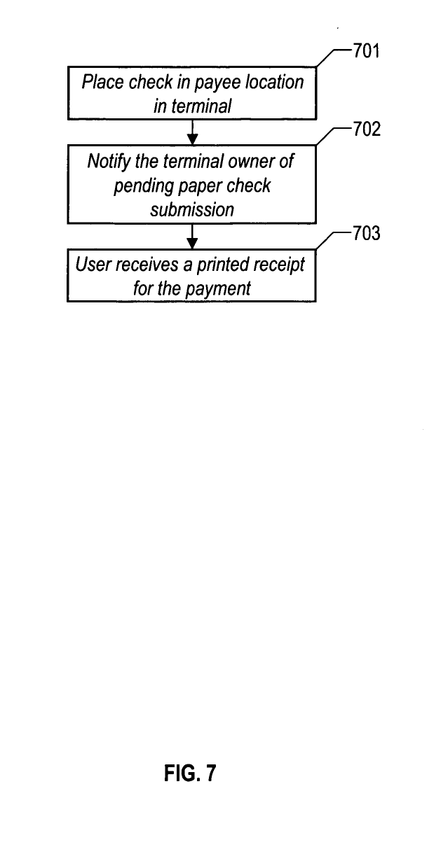

FIG. 7 is a flow diagram of the steps in phase two of the method of the invention when the customer selects to pay with a physical check.

### DETAILED DESCRIPTION OF THE INVENTION

FIG. 1 illustrates a general configuration of the system of the present invention. Shown is a network of remote kiosk terminals. These terminals can be located in any publicly accessible location. Typical kiosk locations can include a supermarket 101, a shopping mall 102 and a bank 103. These kiosk terminals can be connected to a common terminal owner 104 via a communication links 105, 106, and 107. With this communication link, the terminals can send information to the owner when a transaction has occurred at that terminal. In addition it is also possible for the owner to periodically or randomly check on the activity of each terminal.

Referring to FIG. 2, shown is a typical personal check used to make payments of outstanding bills. The physical features, dimensions and characteristics of this type of check are established by the banking industry. As shown on check 200 at the far top left of the check is the name and address 201 of the check owner. At the far top right is the check number 202. The next information entry on the check is the location 203 for the date. The check writer will insert the date that the check is written in this location. Below the date is the ‘Pay to the order of’ designation, where the check writer inserts the name of the “payee’ 204. Adjacent the payee designation is the location for the amount of the check 205. This location is for a number designation of the check amount. Below both the payee designation and the numerical amount designation is the written check amount description 206. In order for the check to be written in proper form, the numerical and written check amounts must match. Below the written check amount is the name of the financial institution 207 holding the account from which the funds will be drawn to pay the amount of the check. This account is usually the account of the check owner. Below the name of the financial institution is a memo line 208. On this line, the check writing can enter a brief description of the nature or purpose of the check. Adjacent the memo line is the location 209 for the check writer to sign the check. This signature gives the financial institution the authority to payee funds out of the check writer's account to the designated payee to satisfy the obligation of the writer to the payee. Below the memo line is the check routing number 210. This number is a numerical identification of the financial institution, the check writer's account number and the check number.

As mentioned, the present invention provides a method to reduce the amount of time required to prepare a check at a point-of-sale location. In the present invention, the check is prepared and printed out at the point-of-sale terminal. FIG. 3 shows the different areas of a check 300 where the check writer inserts information. Because of the standard check design for personal checks, these areas are in the same locations on each personal check. As a result, present software in the terminal can print specific information in each of these locations. For purposes of this description, these locations will be referred to as check fields. The printing process for this present invention can be designed and implemented in a manner that is similar to other standard printing schemes. In FIG. 3, area 301 is the date of the check. The print program can be designed to print out a numerical representation for the date such as 11-10. The numeral ‘11’ represents the month and the numeral ‘10’ represents the date. The other alternative would be to spell out the month i.e. ‘November’. The ‘year’ field 302 can print the last two digits of the current year. Field 303 is the ‘payee’ field. This field will contain the name of the payee. If the commercial establishment the “ABC Company”, then this name would be printed in this field. Field 304 is the location for the numerical amount of the sale. Field 305 is the location for the written amount of the sale. Field 306 is an optional field that describes a purpose for the sale. As mentioned, this information is primarily for the benefit of the check writer. Depending of the technology implemented at the point-of-sale location, the check writer may be able to enter an electronic signature that would be printed on the check in field 307. An example of the technology could be an electronic pad such as those currently used to enter purchaser signatures for credit card transactions. In the present instance, once the check writer enters his/her signature on the electronic pad, the signature would appear on the check in field 307.

Referring to FIG. 4, shown is a flow diagram of the basic steps in the implementation of the method of the present invention. In step 401 the customer activates the bill payment option on the terminal. This activation step could simply be selecting an icon from the terminal desktop screen displayed to the customer. Once the customer selects the bill payment option, a list of payees to which the customer can pay a bill is displayed in step 402. The present invention can only accommodate a finite number of bill payees. This limitation is similar to the limitations on paying certain bills in person at supermarkets. After the customer has viewed the payee list and identified the appropriate payee, the customer in step 403 selects that payee.

At this point, the customer inserts the bill/statement into the terminal in step 404. In step 405, the terminal scans the bill information. The inserted bill has a specific format in which the necessary information for the outstanding bill is easily located from the document and retrieved by the terminal scanner. The present invention can have a specific format for each payee statement within this system. After the identification of the payee and the amount of the bill, customer verifies the payment information in step 406. At this point, the customer writes a check to pay the bill and inserts this check into the terminal in step 407. In step 408, the customer selects a form of payment. The payment method can be either to have an electronic transfer or to have the actual check submitted to the payee. In step 409, the payment is submitted to the identified payee via the terminal. At the completion of this transaction, step 410 provides the customer a receipt which will have the exact date and time of the submission of the payment via the terminal.

In the present invention, the customer will have the option of submitting an electronic check or a physical check. Because of these payment options, the implementation of the method of the present invention is in two phases. FIG. 5 is a flow diagram of the steps in the implementation of phase one of the method of the present invention. As with FIG. 4, in step 501, the customer activates the bill payment option from the terminal. As previously mentioned, this activation process could be merely clicking an icon from the terminal screen. Step 502 displays the list payees to which the customer can pay a bill. The customer identifies and selects the desired payee from the displayed list in step 503. In step 504, the customer inserts payee statement/bill into the terminal document feeder. In step 505, the kiosk terminal then scans the information from the statement. The terminal software retrieves information from the bill. As mentioned, to facilitate ease of scanning and retrieval of information, the bills should be in a predetermined format with the necessary information in specific locations on the documents. After scanning the information from the payee statement, step 506 formulates and presents the payment information to the customer.

In step 507, the customer reviews the payment information. This review may be necessary, if the information on the statement was scanned in incorrectly or if the information in the statement was not legible. If the information is not correct, step 508 gives the customer the opportunity to correct the information. When the determination in step 507 is that the information is correct, the process moves to step 509, where the customer writes a check for payment of the bill. The process moves to step 510 where the kiosk terminal accepts the check inserted by the customer. After the acceptance of the check, the customer now has to select the method of payment in step 511.

As mentioned, the second phase of the method of the present invention describes the form of payment of the bill. Referring to FIG. 6, shown is a flow diagram of the steps in phase two of the method of the invention, when the customer selects to have the funds for the check paid electronically. In this method, the kiosk terminal scans in the check from the customer in step 601. The terminal reads the routing information (see FIG. 2) at the bottom of the check. In step 602 the method creates an e-check from the information on the scanned in check. This e-check is an electronic image of the scanned in check. The process moves to step 603, where there is a determination of the whether the account on which the check was written has sufficient funds to cover the amount of the check. If the determination is that the account does not have sufficient funds to cover the check, the process of the present invention moves to step 604 and terminates with a message to the customer. If the funds are available, the process moves to step 605, where an electronic payment is sent to the payee. In step 606, the payee receives the electronic payment. As part of this electronic payment process, in step 607, the customer is immediately given credit for the payment. At the completion of this step of the transaction, the customer receives a printed confirmation of the payment in step 608. This confirmation could be in the form of the original check that the customer submitted to the terminal. In this case, the confirmation information could be printed on the back of the check. The confirmation information could include the payee name, the amount of the payment, the customer account and the date of the payment.

Referring to FIG. 7, shown is a flow diagram of the steps in phase two of the method of the invention, when the customer selects to have the physical check delivered to the payee. The customer inserts the check into the terminal. In step 701, the submitted check is sorted and placed in the terminal location for that payee. The checks for the various payees can be sorted into small bin locations in the terminal. At this point, the bill is considered timely received by the payee. The next step 702 notifies the terminal owner of a pending check that is deposited in that particular terminal. At the completion of this step of the transaction, the customer receives a printed confirmation of the payment in step 703. The confirmation information could include the payee name, the amount of the payment, the customer account and the date of the payment.

In an alternate embodiment, the customer can have the option of paying the bill with cash instead a check. In this method, the customer would select a cash payment option that could also be displayed on the kiosk screen. Inserted currency would be scanned into the terminal in a manner similar to how other machines such as the automated self-service store checkout machines operate. The payment could then be sent to the payee as an electronic funds transfer.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper cards, floppy disc, hard disk drive, RAM, and CD-ROMs and transmission-types of media, such as digital and analog communications links.

Having thus described the invention, what we claim as new and desire to secure by Letters Patent is set forth in the following claims.

1. A method for paying a bill at a remote terminal location comprising the steps of:
displaying a list of payees to a customer in response to a customer request to pay a bill at the remote terminal location;
identifying a payee from a customer selection of a payee from the displayed list of payees:
determining customer payment information for the selected payee;
receiving a payment instrument from the customer;
submitting the received payment to the selected payee;
submitting customer's selection of an electronic payment plan or a manual payment plan to payee; and
sending customer a payment confirmation receipt.

2. The method as described in claim 1 wherein the payment instrument is a check.

3. (canceled)

4. The method as described in claim 2 wherein said information determination step further comprises prompting customer to submit payment account information.

5. The method as described in claim 2 wherein said payee information submission step further comprises inserting a customer statement from the designated payee.

6. The method as described in claim 5 further comprising after said payment submitting step, the step of prompting the customer to select a payment plan.

7. (canceled)

8. The method as described in claim 1 wherein the electronic payment plan further comprises the steps of:
submitting a written paper check instrument for payment;
creating an electronic version of the submitted check; and
submitting the electronic version of the submitted check to the payee for immediate payment.

9. The method as described in claim 1 wherein the manual payment plan further comprises the steps of:
submitting a written paper check instrument for payment;
storing the written paper instrument in a location within the remote terminal for that designated payee; and
notifying the operator of the payment terminal about the pending submission of a paper transaction.

10. The method as described in claim 9 wherein the customer payment confirmation receipt contains a copy of the transaction and includes a copy of the scanned check image, the name of the payee, the amount of the payment and the date and time of the payment.

11. A computer program product in a computer readable medium for paying a bill at a remote terminal location comprising:
instructions for displaying a list of payees to a customer in response to a customer request to pay a bill at the remote terminal location;
instructions for identifying a payee from a customer selection of a payee from the displayed list of payees;
instructions for determining customer payment information for the selected payee;
instructions for receiving a payment instrument from the customer;
instructions for submitting the received payment to the selected payee;
instructions for submitting customer's selection of an electronic payment plan or a manual payment plan to payee; and
instructions for sending customer a payment confirmation receipt.

12. The computer program product as described in claim 11 wherein the payment instrument is a check.

13. (canceled)

14. The computer program product as described in claim 12 wherein said information determination instructions further comprise instructions for prompting customer to submit payment account information.

15. The computer program product as described in claim 12 wherein said payee information submission instructions further comprise instructions for inserting a customer statement from the designated payee.

16. The computer program product as described in claim 15 further comprising after said payment submitting instructions, instructions for prompting the customer to select a payment plan.

17. (canceled)

18. The computer program product as described in claim 11 wherein the electronic payment plan further comprises instructions for:
submitting a written paper check instrument for payment;
creating an electronic version of the submitted check; and
submitting the electronic version of the submitted check to the payee for immediate payment.

19. The computer program product as described in claim 11 wherein the manual payment plan further comprises instructions for:
submitting a written paper check instrument for payment;
storing the written paper instrument in a location within the remote terminal for that designated payee; and
notifying the operator of the payment terminal about the pending submission of a paper transaction.

20. The computer program product as described in claim 19 wherein the customer payment confirmation receipt contains a copy of the transaction and includes a copy of the scanned check image, the name of the payee, the amount of the payment and the date and time of the payment.
